(19) United States
(12) Patent Application Publication
(10) Pub. No.: US 2008/0254357 A1
(43) Pub. Date: Oct. 16, 2008

(54) Battery conductive plate

(75) Inventor: Yao-Chuan Liu, Hukou Township (TW)

Correspondence Address: Joe McKinney Muncy, PO Box 1364, Fairfax, VA, 22038-1364, US

(73) Assignee: SIMPLO TECHNOLOGY CO. LTD.

(21) Appl. No.: 11/806,189

(22) Filed: May 30, 2007

(30) Foreign Application Priority Data
Apr. 12, 2007 (TW) 96205855

(51) Int. Cl. H01M 2/26

(52) U.S. Cl. 429/161

(57) ABSTRACT

A battery conductive plate includes at least two welding point zones and at least one connecting zone for electrically connecting the welding point zones to one another. The battery conductive plate is characterized in at least one narrow opening that divides the battery conductive plate into a plurality of separated and electrically non-contact conductive plate parts, so that the battery conductive plate may be more firmly welded to the battery terminals using a stick welding machine.

### RELATED APPLICATIONS

This application claims priority to Taiwan Application Serial Number 96205855, filed Apr. 12, 2007, which is herein incorporated by reference.

### FIELD OF THE INVENTION

The present invention relates to a battery conductive plate, and more particularly, to a battery conductive plate divided by a lengthwise extended narrow opening into at least two separated and electrically non-contact conductive plate parts.

### BACKGROUND OF THE INVENTION

Generally, a battery conductive plate is made of pure nickel. FIG. 1 shown a battery conductive plate 800 includes a plurality of welding point zones. A long slot 801 is provided in each of the welding point zones. When a stick welding machine is used to weld the battery conductive plate 800 to terminals of a plurality of batteries 900, two sticks of the welding machine are made to straddle across the long slot 801 to be located on, for example, two opposite welding points 1A and 1B, so that electric current supplied by the stick welding machine flows from the stick at a first side of the long slot 801 through an area of the battery conductive plate at the same first side of the long slot 801, and the battery terminal surface to an area of the battery conductive plate at an opposite second side of the long slot 801, and the other stick at the same second side of the long slot 801 before flowing back to the stick welding machine to form a welding current loop. Therefore, energy transported by the electric current is released instantaneously to weld the battery conductive plate 800 to the battery 900.

When a battery conductive plate made of a material with high electric conductivity is welded to the battery terminal using the stick welding machine, the electric current supplied by the welding machine flows through not only the above-described path to form a loop, but also the conducting material surrounding the long slot 801 to form another current loop. The electric energy is quickly transferred across the highly conductive material to adversely cause dispersion of energy transported by the current flow through the welding points, resulting in insufficiently bonded welding points that tend to cause separation of the battery conductive plate from the battery terminal.

### SUMMARY OF THE INVENTION

A primary object of the present invention is to provide a battery conductive plate that can be always firmly welded to battery terminals using a stick welding machine.

To achieve the above and other objects, the battery conductive plate according to the present invention includes at least two welding point zones and at least one connecting zone for electrically connecting the welding point zones to one another, and is characterized in a narrow opening that divides the battery conductive plate into a plurality of separated and electrically non-contact conductive plate parts.

The battery conductive plate of the present invention may further include a terminal extended from and electrically connected to any one of the plurality of conductive plate parts.

The battery conductive plate of the present invention may further include a locating element made of an electrically nonconductive material positioned between any two adjacent conductive plate parts.

The battery conductive plate of the present invention may be made of a material selected from the group consisting copper, nickel, iron, gold, and silver.

In the battery conductive plate of the present invention, each of the welding point zones includes at least one protrusion. The convex direction makes contact with the battery terminal.

In the battery conductive plate of the present invention, the narrow opening may be a straight linear shape or a zigzag shape.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a top plan view shown a conventional battery conductive plate;

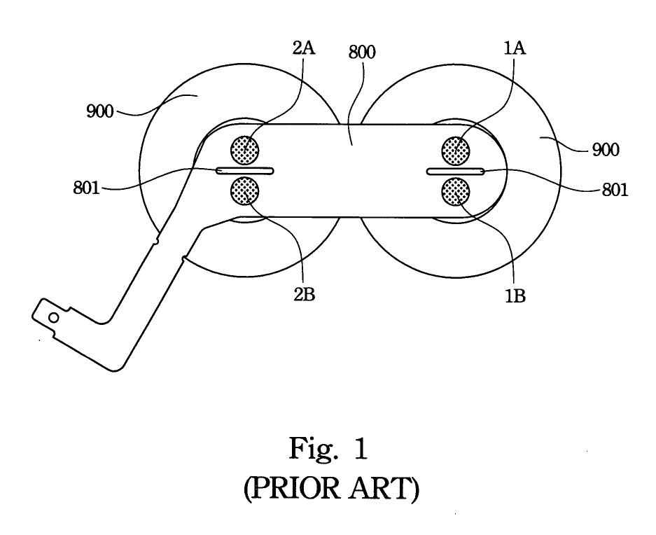

FIG. 2 is a perspective view shown a battery conductive plate according to a first embodiment of the present invention;

FIG. 3 is a top plan view of the battery conductive plate of FIG. 2; and

FIG. 4 is a top plan view of a battery conductive plate according to a second embodiment of the present invention.

### DETAILED DESCRIPTION OF THE PREFERRED EMBODIMENTS

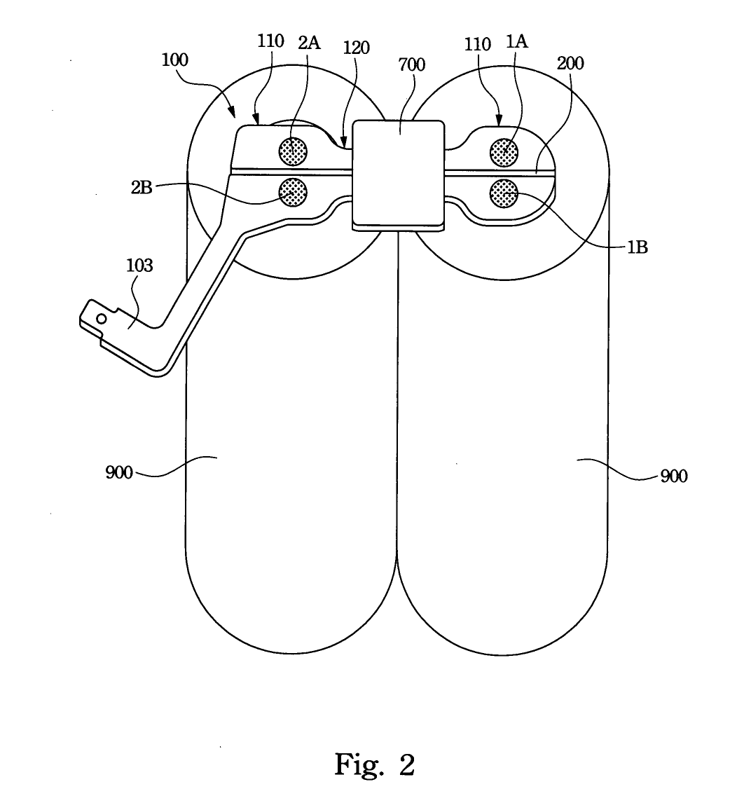

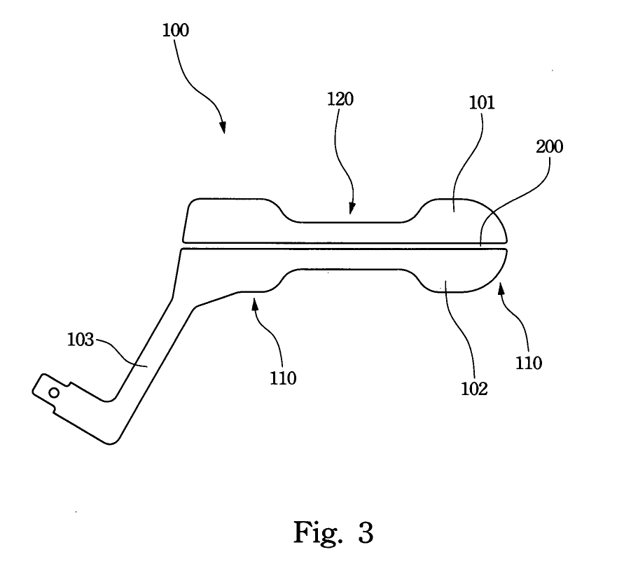

Please refer to FIG. 2 and FIG. 3. FIG. 2 is a perspective view of a battery conductive plate 100 according to a first embodiment of the present invention. FIG. 3 is a top plan view of the battery conductive plate 100.

As shown, the battery conductive plate 100 includes a plurality of welding point zones 110, and a connecting zone 120 for electrically connecting different welding point zones 110 to one another. The shape and size of the welding point zones 110 may be designed to vary according to the shape and size of the battery terminals. Similarly, the connecting zone 120 may have a shape and size that varies with the configuration and size of the batteries as well as the shape and array of a battery pack to be welded to the battery conductive plate 100. The battery conductive plate 100 is divided into a first conductive plate part 101 and a second conductive plate part 102 by a narrow opening 200 continuously extended through the welding point zones 110 and the connecting zone 120. In the first embodiment, the narrow opening 200 is extended through a lengthwise direction of the battery conductive plate 100. The first and the second conductive plate part 101, 102 are completely separated from each other without being in electrical contact with each other.

When the battery conductive plate 100 is to be welded to two batteries using a stick welding machine, initially the two sticks of the welding machine are made to straddle the narrow opening 200 to be in contact with two opposite welding points, such as, for example, the two welding points 1A, 1B shown in FIG. 2, so that current supplied by the welding machine flows from the stick located in the first conductive plate part 101 through the first conductive plate part 101 and the battery terminal surface to the second conductive plate part 102 and the other stick located in the second conductive plate part 102 before flowing back to the stick welding machine to form a welding current loop. Therefore, the supplied current does not flow through other paths to cause electrical energy dispersion, and a battery conductive plate made of a material with high conductivity, such as copper, can also be firmly welded to the battery terminal using the stick welding machine.

To maintain the narrow opening 200 while keeping the first and the second conductive plate part 101, 102 in their electrically non-contact position relative to each other, a locating element 700 is provided between the first and the second conductive plate part 101, 102. The locating element 700 is made of a nonconductive material to prevent electrical contact between the first and the second conductive plate part 101, 102. In the illustrated first embodiment, the locating element 700 is located in the connecting zone 120 without hindering the welding operation at the welding point zones 110. To lead out electric power from a battery pack consisting of multiple batteries 900 electrically connected together via the battery conductive plate 100, the battery conductive plate 100 may include a terminal 103, which may be formed by extending any portion of the first or the second conductive plate part 101, 102 and is electrically connected to the conductive plate part from which the terminal 103 is extended.

It is understood various changes and modifications in the above-described embodiment can be carried out based on the technical concept of the present invention. For example, the narrow opening 200 illustrated in FIGS. 2 and FIG. 3 is in the form of a long and straight line. However, the narrow opening 200 may be any other form, such as a long zigzag line (not shown), so long as the narrow opening 200 extends through the battery conductive plate 100 and is able to keep the first and the second conductive plate part 101, 102 in a separated and electrically non-contact state. In addition, the narrow opening 200 is not limited to only one. For example, there may be multiple narrow openings 200 to divide the battery conductive plate 100 into more than two electrically non-contact conductive plate parts (not shown). In this case, when a stick welding machine is used to weld the battery conductive plate 100 to the terminals of multiple batteries, the two sticks of the stick welding machine may still be separately positioned on any two separated and electrically non-contact conductive plate parts located on the same battery terminal to achieve the same effect intended by the present invention.

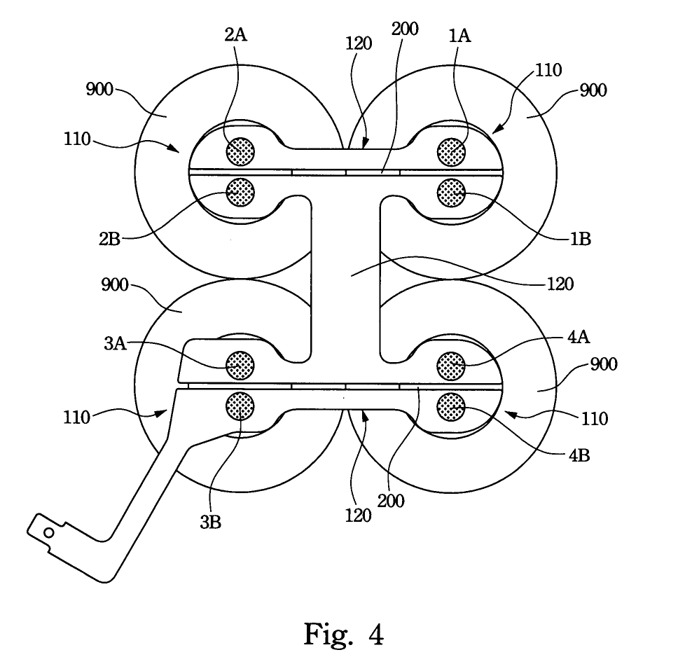

The battery conductive plate 100 shown in FIG. 2 and FIG. 3 is designed for connecting two batteries 900 together. Another battery conductive plate 100 according to a second embodiment of the present invention as shown in FIG. 4 is designed for connecting a plurality of batteries 900 arranged as a square array. To weld the battery conductive plate 100 of the second embodiment to the terminals of the batteries 900, the sticks of the stick welding machine may be sequentially positioned against multiple pairs of two opposite welding points, such as the welding point pairs (1A, 1B), (2A, 2B), (3A, 3B), and (4A, 4B), to complete the welding. The surface where the welding point zone 110 makes contact with the battery terminal may have a protrusion (not shown) located thereon, so as to obtain the smallest possible contact area between the metal conductive plate and the battery terminals, and allow the energy transported by the welding current to be concentrated only in the small contact area to obtain and enhance the welding effect.

The battery conductive plate of the present invention may be made of different metal materials, such as pure and plated copper, nickel, and iron, and alloys thereof. Moreover, in consideration of the electric conductivity, the weldability, and the durability of the battery conductive plate, it is also possible to plate the battery conductive plate of the present invention with a metal having high electric conductivity and stability, such as gold and silver. And, all these applied embodiments should also be included in the scope of the present invention.

From the above-described embodiments, it is ensured the battery conductive plate of the present invention made of a material with high electrical conductivity may also be firmly welded to the battery terminals using a stick welding machine.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A battery conductive plate for welding to battery terminals, comprising:
at least two welding point zones;
at least one connecting zone for electrically connecting the welding point zones to one another; and
at least one narrow opening to divide the battery conductive plate into a plurality of electrically non-contact conductive plate parts.

2. The battery conductive plate as claimed in claim 1, further comprising a terminal extended from and electrically connected to any one of the plurality of conductive plate parts.

3. The battery conductive plate as claimed in claim 1, further comprising a locating element made of an electrically nonconductive material positioned between any two adjacent conductive plate parts.

4. The battery conductive plate as claimed in claim 1, wherein a material for forming the battery conductive plate is selected from the group consisting of copper, nickel, iron, gold, and silver.

5. The battery conductive plate as claimed in claim 1, wherein each of the welding point zones has a protrusion located on surface where the welding point zone makes contact with the battery terminal.

6. The battery conductive plate as claimed in claim 1, wherein the narrow opening is in the form of a long and straight linear line.

7. The battery conductive plate as claimed in claim 1, wherein the narrow opening is in the form of a long zigzag line.
